(19) United States
(12) Patent Application Publication
(10) Pub. No.: US 2008/0105208 A1
(43) Pub. Date: May 8, 2008

(54) Right Spot

(76) Inventor: Teri S Hamrick, Earlysville, VA (US)

Correspondence Address: WILSON DANIEL SWAYZE, JR., 3804 CLEARWATER CT., PLANO, TX, 75025, US

(21) Appl. No.: 11/557,642

(22) Filed: Nov. 8, 2006

(51) Int. Cl. A01K 1/01

(52) U.S. Cl. 119/165

(57) ABSTRACT

A dog waste holder device includes a first upper nesting frame, a second lower nesting frame to form a reservoir and to cooperate with the first upper nesting frame to accept a grass-like mat and an inverted upward projection to support the grass-like mat. The first nesting frame has an inclined wall which extends downward and extends into and secures free edge of grass-like mat firmly in place.

### 1. FIELD OF THE INVENTION

This invention relates to a device for the collection and disposal of dog waste. More particularly, this invention securely holds self-draining Astroturf on two nesting frames.

### 2. DESCRIPTION OF RELATED ART

Devices that ease the arduous task of housebreaking a puppy are well known in the art. Even after housebreaking is successful, these devices are useful when a pad-trained dog is left indoors for extended periods of time. Such devices are disclosed, for example, in U.S. Pat. Nos. 4,715,320; 6,059,247; 5,630,376; 4,949,673; 5,355,837; and the references cited therein. These devices hold newspaper or an absorbent sheet of material in place to prevent a dog's waste from leaking onto a floor surface and allow a dog to eliminate waste in a predetermined area. The absorbent sheet of material held by most prior art devices is a leak-proof pad having a plastic backing that prevents waste from leaking through the pad and onto a floor surface. Some of the prior art devices use trays or reservoirs to prevent waste from leaking onto the floor surface. Another device, U.S. Pat. No. 4,715,320, uses three hoops to loosely retain newspaper or other material to prevent waste from leaking. U.S. Pat. No. 6,550,423 to Pope discloses an absorbent dog waste disposal pad holder lacking an underlying bottom wall and having nestable upper and lower frames that cooperate to form a peripheral wall to securely hold the periphery of a disposable, absorbent pad there between. Each nestable upper and lower frame comprises first and second frame members. The first and second frame members of the lower frame preferably comprise opposite side ends that interlock to form the lower frame. The first and second frame members of the upper frame preferably comprise ends that abut to form the upper frame. Preferably, the frames of the absorbent dog waste disposal pad holder are generally rectangular shaped, are made of moldable polymeric material and have an inverted U-shaped cross section. A method of assembling the subject absorbent dog waste disposal pad holder is also disclosed.

However, many of the prior art devices contain complicated parts, are hard to assemble and to maintain and are bulky. Many of the prior art devices have square corners or edges which encourage chewing. Some devices do not securely hold the substrate material in place increasing the likelihood that the dog will chew or eat the substrate or drag it through the house making a mess. Other devices are not durable enough to withstand the repeated weight of a large dog or render it difficult to remove a soiled sheet of material. Most prior art devices also utilize cloth or cloth-like substrates which can actually condition the dog to want to eliminate on common household items such as rugs, carpets, and furniture making housetraining more rather than less difficult. These devices do not simulate grass that is found in the yard. What is needed is a device that is inexpensive, is easy to manufacture, has simple but reliable parts, can be packaged and stored compactly and is easy to assemble. The device needs to utilize a substance not found in the house in order to condition the dog to prefer to eliminate only on the unique substance or outside. The device also needs to be durable. These and other advantages are provided by the invention disclosed below.

### SUMMARY OF THE INVENTION

A dog waste disposal holder is disclosed herein that provides significant advantages over the prior art. Structural advantages include a bottom surface with inverted U shaped upward projections and a small number of compact components that are durable and easy to assemble. The dog waste disposal holder has nestable upper and lower generally rectangular frames, with first and second frame members. The first frame member abuts the second frame member. The first and second frame members each preferably comprise a peripheral wall which extends around the periphery of the first and second frame member and abut each other in order to hold the first upper nesting frame to the second lower nesting frame.

The dog waste disposal holder can be packaged and stored compactly, has simple but reliable parts and is easy to assemble. The dog waste disposal holder also is durable. The use of the present invention makes housebreaking a dog easy and provides a single place for the dog to eliminate waste when left indoors for extended periods. While the invention can be easily utilized by any dog owner, the dog waste disposal is of special use to dog breeders. It provides a sensible way for breeders to keep their weaning pens cleaner. The invention will help breeders to condition puppies at a very young age to prefer to eliminate on a textured grass-like substance rather than the cloth or cloth-like substrates commonly used today. In addition, the upper frame holds the grass like mat securely in place reducing the likelihood that the dog or puppy will chew on the mat or drag it from the lower tray.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the second lower nesting frame;

FIG. 2 illustrates a top view of the second lower nesting frame;

FIG. 3 illustrates a cross-sectional view of the second lower nesting frame;

FIG. 4 illustrates a portion of the second peripheral wall of the second lower nesting frame;

FIG. 5 illustrates a perspective view of the first upper nesting frame;

FIG. 6 illustrates a top view of the first upper nesting frame;

FIG. 7 illustrates a cross-sectional view of the first upper nesting frame;

FIG. 8 illustrates a portion of the first peripheral wall of the first upper nesting frame;

FIG. 9 illustrates a perspective view of the first upper nesting frame and the second lower nesting frame;

FIG. 10 illustrates a top view of the first upper nesting frame and the second lower nesting frame;

FIG. 11 illustrates a cross-sectional view of the first upper nesting frame and the second lower nesting frame;

FIG. 12 illustrates a portion of the first peripheral wall of the first upper nesting frame and the second peripheral wall of the second lower nesting frame;

FIG. 13 illustrates a side view of the dog waste holder and a self-draining grass mat.

### DETAILED DESCRIPTION OF THE PREFERRED EMBODIMENT

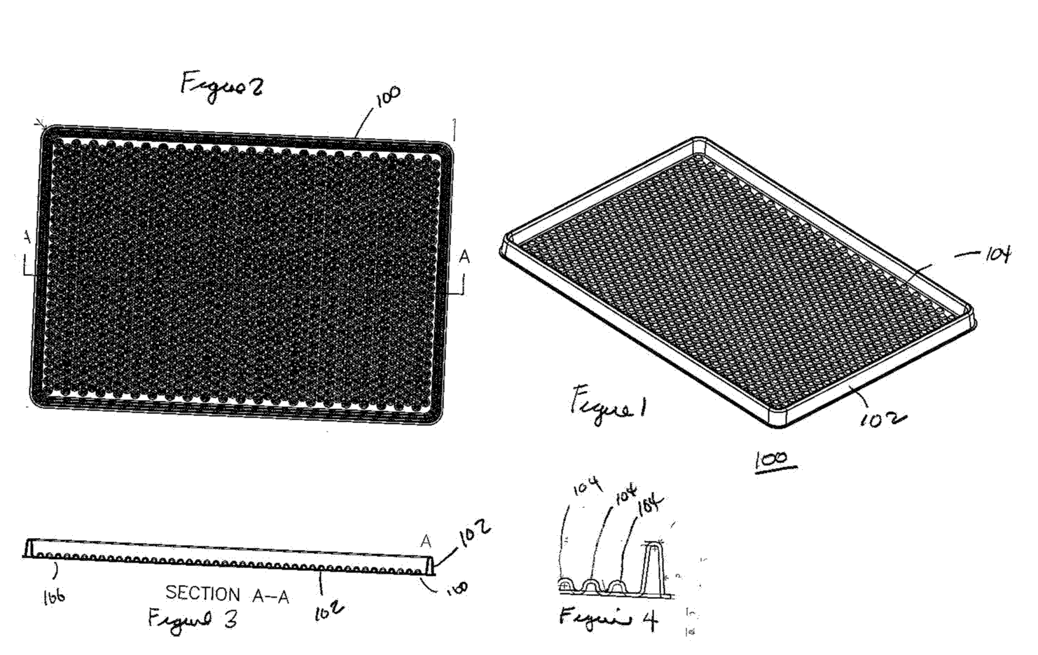

FIGS. 1-4 illustrate the second lower nesting frame 100 of the dog waste holding device 900 which is generally rectangular shaped. Other shapes are within the scope of the invention. FIG. 1 illustrates a second peripheral wall 102 as a second frame member which extends around the periphery of the second lower nesting frame 100. FIG. 1 additionally illustrates that the second lower nesting frame 100 includes rows and columns of inverted U-shaped upward projections 104 extending from the bottom surface of the second lower nesting frame 102. The inverted U-shaped upward projections 104 are shown extending along the traverse direction of the second lower nesting frame 100 to form rows and along the longitudinal direction of the second lower nesting frame 100 to form columns. The inverted U-shaped upward projections 104 could extend along an angle in other embodiments.

FIG. 2 illustrates a top view of the second lower nesting frame 100 including the second peripheral wall 102 and the rows and columns of inverted U-shaped upward projections 104.

FIG. 3 illustrates a cross-sectional view along cross section line AA as shown in FIG. 2 and includes the second peripheral wall 102 and the rows and columns of inverted U-shaped upward projections 104.

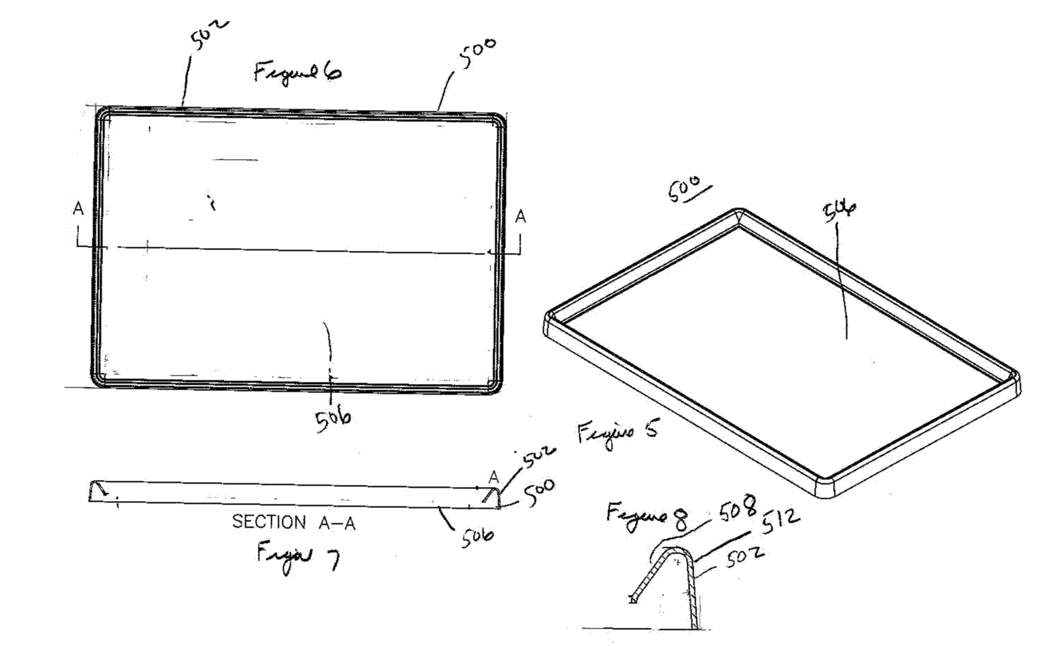

FIG. 4 shows a portion of the second peripheral wall 102 and the inverted U-shaped upward projections 104. While FIG. 4 shows the U shaped upward projections 104, other shapes such as V shape are within the scope of the invention. The space between the inverted U-shaped upward projections 104 forms a reservoir for the dog waste especially the urine. The projections 104 also allow the grass-like mat to rest above the reservoir keeping the mat dry.

FIG. 4 shows that the second peripheral wall 102 is substantially inverted U-shaped and extends further upwards than the inverted U-shaped upward projections 104. This allows the first upper nesting frame to be nested with the second lower nesting frame. Both the first upper nesting frame and the second lower nesting frame may have rounded corners in order to discourage the dogs from chewing on the corners of the first upper nesting frame and the second lower nesting frame.

FIG. 5 illustrates a perspective view of the first upper nesting frame 500 which is generally rectangular in shape and which includes a first peripheral wall 104 as a first frame member formed around the periphery of the first upper nesting frame 500. FIG. 5 additionally illustrates that the first upper nesting frame 500 includes an inclined wall 508 which extends from the first peripheral wall 502 to secure the grass like mat 1302 or Astroturf or others similar type of material which resembles grass. The grass like mat 1302 or Astroturf or substitute grass provides a familiar medium in which the dog is encouraged to eliminate the waste. The grass-like mat 1302 includes drain holes 1304 so the liquid waste drains through into the reservoir created by the upward u-shaped projections 104. The inward edge of the inclined wall 508 defines an aperture 506 which is substantially centered within the first upper nesting frame 500. The lower and upper frames are made of a moldable polymeric material or other suitable material.

FIG. 6 illustrates a top view of the first upper nesting frame 500 showing the first peripheral wall 502, the inclined wall 508 and the aperture 506.

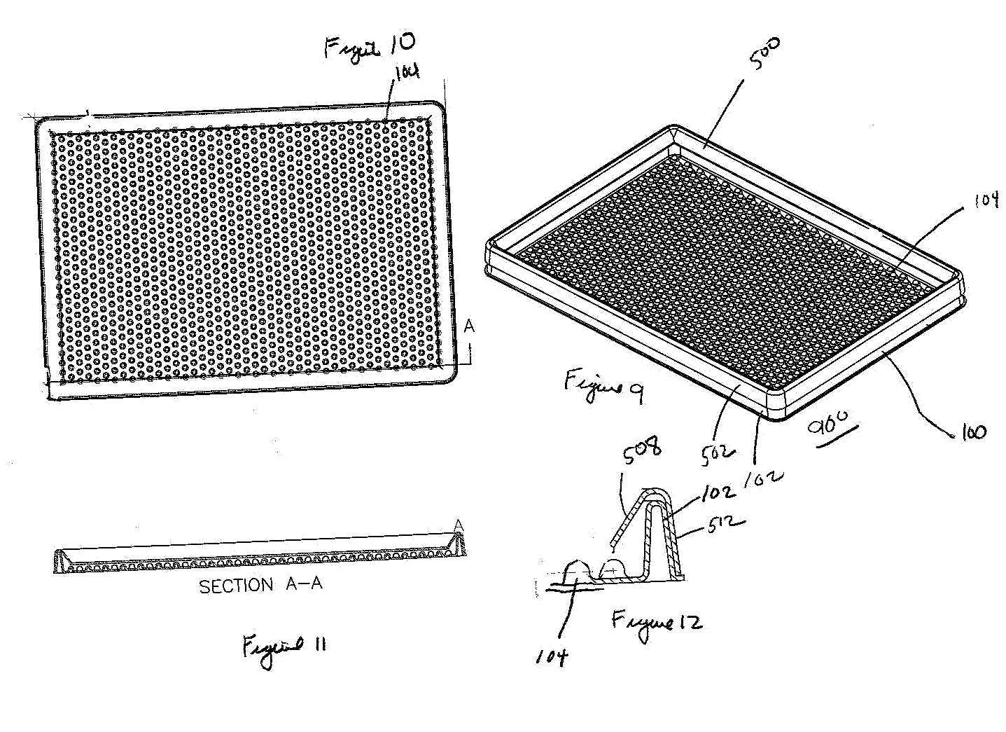

FIG. 7 illustrates a side view of the first upper nesting frame 500 showing the first peripheral wall 502, the inclined wall 508 and the aperture 506.

FIG. 8 illustrates a portion of the first upper nesting frame 500 including the first peripheral wall 502. The first peripheral wall 502 includes a first inwardly slanting wall 512 for the exterior of the first upper nesting frame 500 and a second inwardly slanting wall 508 for the interior of the first upper nesting frame 500. At one end of the second inwardly slanting wall 508, the inclined wall 508 extends into the interior of the first upper nesting frame 500. The inclined wall 508 inserts into the grass-like mat 1302 to substantially cover the entire free edge of the grass like mat and secure the mat in the lower nesting tray.

FIG. 9 illustrates a perspective view of the dog waste holding device 900 showing the first upper nesting frame 500 in the second lower nesting frame 100. FIG. 9 shows the inverted U-shaped upward projections 104 and the supporting base 504.

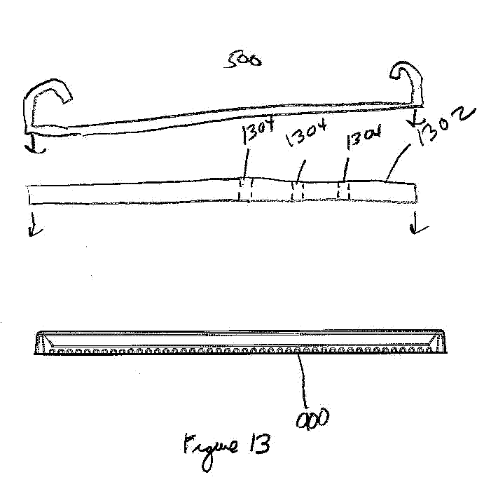

FIG. 10 illustrates a top view of the dog waste holding device 900 showing the supporting base 504 and the inverted U-shaped upward projections 104.

FIG. 11 illustrates a side view of the dog waste holding device 900 showing the inclined wall 508 extending downward towards the inverted U-shaped upward projections 104.

FIG. 12 illustrates the first frame member cooperating with the second frame member. More particularly, the first peripheral wall 502 is lowered over the second peripheral wall 102 so that a portion of an interior surface of the first peripheral wall of 502 abuts a portion of the exterior surface of the second peripheral wall 102. The inclined wall 508 extends towards the inverted U-shaped upward projections 104. Once the grass mat is in place, the inclined wall 508 holds it securely in place.

FIG. 13 illustrates the dog waste holder device 900 accepting the grass like mat 1302 including drain holes 1304 which extends through the grass like mat 1302 to allow the liquid waste to pass through the grass-like mat 1302. The grass like mat 1302 may be Astroturf or any other suitable grass like mat or grass like device through the aperture 506 and on to the inverted U-shaped upward projections 104. The grass-like mat 1302 is designed with drain holes 1304 so the urine will drain through into the reservoir created by the inverted U-shaped projections 104. The lower frame supports the turf. The upper frame is connected to the lower frame after the turf is positioned

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A dog waste holder device, comprising:
a first upper nesting frame;
a second lower nesting frame to cooperate with said first upper nesting frame to accept a grass like mat;
an inverted upward projection to support said grass-like mat and provide a reservoir for the liquid dog waste.

2. A dog waste holder device as in claim 1, wherein said first upper nesting frame is substantially rectangular.

3. A dog waste holder device as in claim 1, wherein said first upper nesting frame is substantially rectangular.

4. A dog waste holder device as in claim 1, wherein said first upper nesting frame includes a supporting base.

5. A dog waste holder device as in claim 1, wherein said first upper nesting frame includes an inclined wall, which extends downward and towards the grass-like mat to cover and secure the free edge firmly in place.

6. A dog waste holder device as in claim 1, wherein said first nesting frame includes a first peripheral wall around the periphery of said first nesting frame.

7. A dog waste holder device as in claim 1, wherein said second nesting frame includes a second peripheral wall around the periphery of said second nesting frame.

8. A dog waste holder device as in claim 1, wherein said first nesting frame nests with said second nesting frame.

9. A dog waste holder device as in claim 1, wherein said first nesting frame includes a first peripheral wall and a second nesting frame includes a second peripheral wall, and wherein said first peripheral wall abut said second peripheral wall.

10. A system for a dog waste holder device, comprising:
a first upper nesting frame;
a second lower nesting frame to form a reservoir and to cooperate with said first upper nesting frame to accept a grass-like mat;
an inverted upward projection to support said grass like mat.

11. A system for a dog waste holder device as in claim 10, wherein said first upper nesting frame is substantially rectangular.

12. A system for a dog waste holder device as in claim 10, wherein said second lower nesting frame is substantially rectangular.

13. A system for a dog waste holder device as in claim 10, wherein said first upper nesting frame includes a supporting base.

14. A system for a dog waste holder device as in claim 10, wherein said first upper nesting frame includes an inclined wall.

15. A system for a dog waste holder device as in claim 10, wherein said first nesting frame includes a first peripheral wall around the periphery of said first nesting frame.

16. A system for a dog waste holder device as in claim 10, wherein said second nesting frame includes a second peripheral wall around the periphery of said second nesting frame.

17. A system for a dog waste holder device as in claim 10, wherein said first nesting frame nests with said second nesting frame.

18. A system for a dog waste holder device as in claim 10, wherein said first nesting frame includes a first peripheral wall and a second nesting frame includes a second peripheral wall, and wherein said first peripheral wall abut said second peripheral wall.
